(19) United States
(12) Patent Application Publication
(10) Pub. No.: US 2017/0098202 A1
(43) Pub. Date: Apr. 6, 2017

(54) BILL PAYMENT SYSTEM

(71) Applicant: Andrew Fitz Albert Sam, Brooklyn, NY (US)

(72) Inventor: Andrew Fitz Albert Sam, Brooklyn, NY (US)

(21) Appl. No.: 15/278,678

(22) Filed: Sep. 28, 2016

Related U.S. Application Data
(60) Provisional application No. 62/237,371, filed on Oct. 5, 2015.

(51) Int. Cl. G06Q 20/10; G06Q 20/32; G06Q 20/24

(52) U.S. Cl. CPC G06Q 20/10; G06Q 20/24; G06Q 20/3255

(57) ABSTRACT

An Internet based bill payment system allowing a consumer to utilize a third-party payment service to pay a payee, such as a merchant or a governmental entity, is provided. The third-party payment service may be coupled to a disposable credit card associated with credit card account information for the transfer of funds to the payee. The disposable credit card may be adapted to communicate or enable the communication of such credit card account information at a point of transaction terminal, in person or remotely via SMS, of the payee via a computer readable element.

### CROSS-REFERENCE TO RELATED APPLICATION

This application claims the benefit of priority of U.S. provisional application No. 62/237,371, filed 5 Oct. 2015, the contents of which are herein incorporated by reference.

### BACKGROUND OF THE INVENTION

The present invention relates to bill payment systems and, more particularly, to an Internet based bill payment system allowing a consumer to utilize a third-party payment service via a disposable credit card.

Credit cards (and debit cards that leverage credit card processing networks) are a widely used financial instrument, and thus offer the convenience of being almost universally accepted. However, the buyer credit card account underlying the transfer of funds can be compromised or otherwise accessed by those intent on stealing from the credit card user-buyer, which is the risk countering the reward of convenience.

Providing the convenience of the credit card while eliminating its attendant risks would be a boon to consumers and merchants alike (as merchants get bilked billions of dollars a year in fraudulent charges).

As can be seen, there is a need for an Internet based bill payment system allowing a consumer to utilize a third-party payment service via a disposable credit card. Thereby enabling user-consumers the convenience of paying by credit card, without the risk of having credit card information and/or personal information stolen, compromised, or otherwise misappropriated.

### SUMMARY OF THE INVENTION

In one aspect of the present invention, a bill payment system includes a user-consumer; a third-party payment service providing a disposable credit card couple to a credit card account never associated with the user-consumer; and a third-party seller selling the disposable credit card to the user-consumer so that the user-consumer can utilize the credit card account at a point of transaction provided by a payee.

In another aspect of the present invention, the bill payment system, includes a user-consumer; a third-party payment service providing a disposable credit card couple to a credit card account never associated with the user-consumer; a third-party seller selling the disposable credit card to the user-consumer so that the user-consumer can utilize the credit card account; a computer readable element provided by the disposable card, wherein the computer readable element includes a unique pin number associated with the credit card account, and wherein the computer readable element is readable via the point of transaction; and a point of transaction provided by a payee, wherein the point of transaction is accessible by SMS for communicating the unique pin number, wherein the payee provides a bill account number that the user-consumer may match with the unique pin number via the point of transaction.

In yet another aspect of the present invention, a computer implemented method of paying bills includes the steps of providing a disposable credit card associated with a third-party payment service, wherein the disposable credit card includes a unique pin number associated with the third-party payment service; selling the disposable credit card to user-consumers not associated with the third-party payment service; providing a bill account number associated with a predetermined bill of a payee, wherein the predetermined bill is also associated with the user-consumer; and providing a point of transaction accepting the unique pin number and the bill account number, wherein the point of transaction is accessible by the user-consumer via SMS.

These and other features, aspects and advantages of the present invention will become better understood with reference to the following drawings, description and claims.

### BRIEF DESCRIPTION OF THE DRAWINGS

FIG. 1 is a front view of an exemplary embodiment of the present invention; and

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an Internet based bill payment system allowing a consumer to utilize a third-party payment service to pay a payee, such as a merchant or a governmental entity. The third-party payment service may be coupled to a disposable credit card associated with credit card account information for the transfer of funds to the payee. The disposable credit card may be adapted to communicate or enable the communication of such credit card account information at a point of transaction terminal, in person or remotely via SMS, of the payee via a computer readable element.

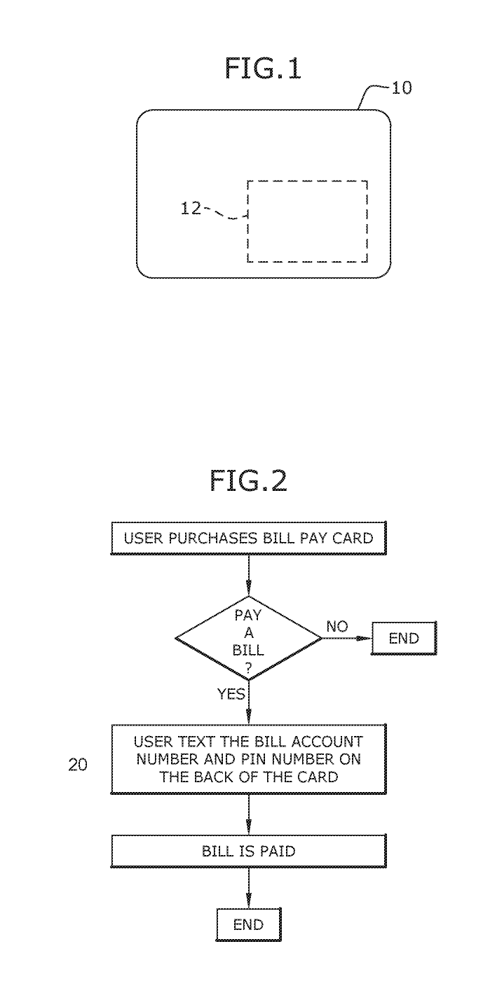

Referring to FIGS. 1 and 2, the present invention may include at least one computer with a user interface. The computer may include at least one processing unit coupled to a form of memory. Each computer may include, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The invention relates generally to bill payment systems. More particularly, the invention relates to an Internet based bill payment system allowing a consumer to utilize a third-party payment service to pay a payee, such as a merchant or a governmental entity. The third-party payment service may be coupled to a disposable credit card 10 associated with credit card account information for the transfer of funds to the payee. The disposable credit card 10 may be adapted to communicate or enable the communication of such credit card account information at a point of transaction terminal, in person or remotely via SMS, of the payee via a computer readable element 12. The communication of such credit card account information may be used to make a funds transfer request, which if accepted comes from the third-party payment service and/or their issuing bank at which the third-party payment service's credit card account is maintained. The computer readable element 12 may provide a pin number or other unique identification number associated with the third-party payment service.

The disposable credit card 10 may be made available at any brick and mortar or online store, and can be purchase by any standardly accepted payment methods: cash, check, credit card, the like. The disposable credit card enables users to pay their bills, pay merchants and the like without the fear of their credit card account or personal information becoming compromised because the disposable credit card 10 is coupled to the third-party payment service's account.

The disposable credit card 10 may provide a printable surface area for applying a printed, graphically or otherwise, message or symbol. The message could be promotional, such as an advertisement used by the third-party payment service, the seller of the card, or others willing to pay for the advertisement space.

In certain embodiments, the method of using the present invention may include the following. The bill payment system disclosed above may be provided. A user-consumer interested in paying a bill could text (SMS) the respective bill account number and the pin number on the computer readable element 12 of the disposable card 10, in step 20, and the bill would be paid by the third-party payment service.

In other embodiments, the disposable card 10 may be a disposable bill pay shop online card for shopping online; a disposable money transfer card for receiving money transfers; and a disposable card for making money deposits.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A bill payment system, comprising:
a user-consumer;
a third-party payment service providing a disposable credit card couple to a credit card account never associated with the user-consumer; and
a third-party seller selling the disposable credit card to the user-consumer so that the user-consumer can utilize the credit card account at a point of transaction provided by a payee.

2. The bill payment system of claim 1, wherein the disposable credit card has a computer readable element providing a unique pin number associated with the credit card account, wherein the computer readable element is readable via the point of transaction.

3. The bill payment system of claim 2, wherein the point of transaction is accessible by SMS for communicating the unique pin number.

4. The bill payment system of claim 3, wherein the payee provides a bill account number that the user-consumer may match with the unique pin number via the point of transaction.

5. The bill payment system of claim 1, wherein the disposable card provides a printable surface area for applying a printed, graphically or otherwise, message or symbol.

6. A bill payment system, comprising:
a user-consumer;
a third-party payment service providing a disposable credit card couple to a credit card account never associated with the user-consumer; and
a third-party seller selling the disposable credit card to the user-consumer so that the user-consumer can utilize the credit card account;
a computer readable element provided by the disposable card, wherein the computer readable element includes a unique pin number associated with the credit card account, and wherein the computer readable element is readable via the point of transaction; and
a point of transaction provided by a payee, wherein the point of transaction is accessible by SMS for communicating the unique pin number, wherein the payee provides a bill account number that the user-consumer may match with the unique pin number via the point of transaction.

7. A computer implemented method of paying bills, comprising the steps of:
providing a disposable credit card associated with a third-party payment service, wherein the disposable credit card includes a unique pin number associated with the third-party payment service;
selling the disposable credit card to user-consumers not associated with the third-party payment service;
providing a bill account number associated with a predetermined bill of a payee, wherein the predetermined bill is also associated with the user-consumer; and
providing a point of transaction accepting the unique pin number and the bill account number, wherein the point of transaction is accessible by the user-consumer via SMS.
